(19) United States
(12) Patent Application Publication
(10) Pub. No.: US 2011/0162855 A1
(43) Pub. Date: Jul. 7, 2011

(54) CORE REMOVAL SYSTEM AND METHOD

(76) Inventor: BRIAN ROBERT VINCEL, Charlottesville, VA (US)

(21) Appl. No.: 13/048,425

(22) Filed: Mar. 15, 2011

Related U.S. Application Data
(63) Continuation of application No. PCT/US2009/057146, filed on Sep. 16, 2009.
(60) Provisional application No. 61/097,959, filed on Sep. 18, 2008.

(51) Int. Cl. A01B 45/02

(52) U.S. Cl. 172/1; 172/22

(57) ABSTRACT

A hollow coring tine with an extension that may be used on several types of reciprocating aerifiers provides core collection and removal from turf. In one embodiment, the extension ensures that the cores are expelled in a pre-determined position with the predetermined position adjustable between about zero and about 90 degrees to the vertical plane, the cores thereby ending up in a collecting bag, a conveyor belt, a core processor, etc. Moreover, because the cores are “caught” in a device that is off the ground, the cores do not touch the turf, directly or indirectly. When the extension is a hose, it is possible to suck the cores through the hose, directly into a collecting container. The hollow coring tine with extension may therefore prevent the turf from being damaged by other core collecting devices, like core collectors.

### CROSS REFERENCE TO RELATED APPLICATIONS

This application claims benefit and priority under 35 U.S.C. §119(e) from U.S. Provisional Application No. 61/097,959 filed Sep. 18, 2008, entitled CORE REMOVAL SYSTEM, the disclosure of which is incorporated by reference herein in its entirety.

### BACKGROUND OF THE INVENTION

1.0 Field of the Invention

This invention generally relates to a system and method for a hollow coring tine for aerating different kinds of turf and, more particularly, relates to a system and method for a hollow coring tine that may be configurable with existing aerators, whose tine heads make a reciprocating movement.

2.0 Related Art

In the past few years the cost of fertilizer, fuel, and supplies needed to manage turf areas have reached an all-time high. In the same period of time, the income of the commercial activities on these turf areas has dropped enormously. Golf course superintendents are frequently struggling to find areas to cut their budgets. They are often forced to do the same amount of work with many fewer laborers than in the past. One of the most laborious tasks is the aerification process. The process includes pulling a plug of thatch and soil from the turf.

Aerification relieves compaction, improves water penetration, removes thatch and provides an overall healthier environment for the turf to grow. The process of removing the cores is often very time-consuming. Part of the reason is the fact that the current hollow coring tines are still the same as years ago. The way and direction the core exits the hollow coring tine cannot be controlled and depends on several factors like thatch composition, soil structure, tine size, tine speed, etc. This typically results in the cores flying in all directions, ending up somewhere on the turf.

Removing the cores, which may have been broken in small pieces, takes a lot of labor and/or expensive machines to clean the surface. Often the turf area has to be closed for executing this job. At this moment there are already devices in the market-place in an attempt to help some aspects of these issues, but it is not a very comprehensive solution. Currently, deflector plates are used to guide the cores out of the machine, or a core scraper is used to move the cores over the turf in rows. in all these solutions, the turf is hurt by the weight and/or the moving devices that are carried over the turf to (re)move the cores in a certain direction.

### SUMMARY OF THE INVENTION

With the aforementioned problems in mind, a new aeration device for collecting, processing and/or conveying the cores is provided to overcome the shortcomings of the prior art.

In one aspect, an apparatus for aerating turf for use with a hollow tine includes a hollow extension having a circumference and a length and having at least one bend along the length and configured to be connected to the hollow tine, wherein the extension is configured to receive a plug traversing and exiting the hollow tine and configured to direct the plug in a direction away from the hollow tine while keeping the plug and broken portions of the plug confined until expelled.

In another aspect, an apparatus for aerating turf includes an aerifier configured to be propelled along the surface of the turf, the aerifier includes a plurality of hollow tines configured to be moved in a vertical reciprocating manner while the aerifier is moved along the surface of the turf to remove one or more plugs from the turf and at least one hollow extension connected to a respective one of the plurality of hollow tines to expel the one or more plugs and/or portions thereof in a direction away from the respective one of the plurality of hollow tines.

In yet another aspect, a method for aerating turf is provided that includes providing a plurality of hollow tines configured to be moved in a reciprocating manner while being moved along the surface of the turf to remove one or more plugs from the turf and providing at least one hollow extension connected to a respective one of the plurality of hollow tines to expel the one or more plugs and/or portions thereof in a direction away from the respective one of the plurality of hollow tines thereby facilitating convenient collection of the one or more plugs by a centralized collection technique and avoiding discarding of the one or more plugs back onto the turf.

In yet another aspect, an apparatus for aerating turf includes means for removing cores from the turf configured to be moved in a reciprocating manner and means for expelling the cores or portions thereof in a direction away from the means for removing, wherein the means for expelling has a circumference and a length and is connectable to the means for removing.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is a perspective view of a common reciprocating aerifier, according to the prior art;

FIG. 2 is an exemplary embodiment of a common reciprocating aerifier, configured with hollow tines in combination with a collecting container, according to principles of the invention;

FIG. 3 is another exemplary embodiment of a common reciprocating aerifier, configured with hollow tines in combination with a conveyor belt for conveying the cores directly into a trailer, according to principals of the invention;

FIG. 4 is another exemplary embodiment of a common reciprocating aerifier, equipped with the hollow tines in combination with a processing device, that crunches the plug/core and spreads the sand portion of the plug/core back onto the turf, configured according to principles of the invention;

FIG. 5 is a side view of a standard hollow coring tine with top eject, plugging a core, according to the prior art;

FIG. 6 is a side view of a standard hollow coring tine with a side eject, plugging a core, according to the prior art;

FIG. 7 is a side view of another exemplary embodiment of a hollow coring tine with top exit, configured according to principles of the invention;

FIG. 8 is a side view of another exemplary embodiment of a hollow coring tine with side eject, configured according to principles of the invention;

FIG. 9 is a side view of another exemplary embodiment of a hollow coring tine with top eject, and a flexible conduit conveying the cores, configured according to principles of the invention;

FIG. 10 is a side view of another exemplary embodiment of the hollow coring tine, showing that the extension can be configured in different positions, according to principles of the invention; and

FIG. 11 is a side view of another exemplary embodiment of a hollow coring tine, with a mechanism to prevent the core from moving backwards, configured according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatuses, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention. The system and method is described herein in relation to a golf course venue, but other venues are certainly possible and contemplated by the invention.

The system and method of the invention includes providing a new generation of hollow

coring tine that delivers its core to a pre-determined area to obviate a need to clean up cores from a turf surface. Also, from this area the core may be further processed. Catching the core before the core touches down on the turf may be very time efficient and may provide for a better looking turf such as at golf courses. Such a capability may simplify the hollow coring process. In return, a golf course superintendant, for example, may be willing and able to core a golf course more frequently. This may make the turf healthier, so less fertilizer is needed, and hence more play may be possible, etc.

The system and method of invention includes providing more comprehensive solutions to the problems related to currently available devices. In one aspect, the hollow tine may expel the cores in a pre-defined or pre-determined direction, enabling a second device to collect, process and/or convey the cores or plugs. In one aspect, the weight of the cores is prevented from being in contact with the turf.

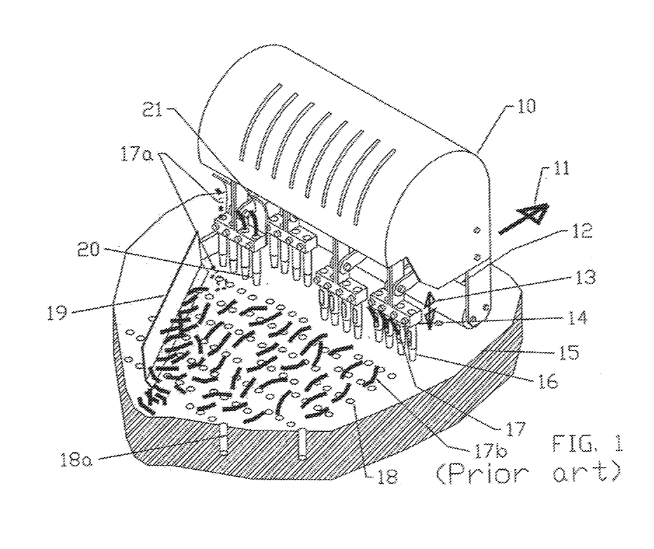

FIG. 1 is a perspective view of a common reciprocating aerifier, according to the prior art, moving forward 11 over the turf 15, pulled or pushed by a power unit (not shown), and supported by roller 12. The tine heads 14 may move up and down 13, typically in a fixed sequence. In some applications, the up and down motion may be vertical or at an angle to vertical. On the right side of the machine (viewed from behind the machine) the tine head may be equipped with one or more standard hollow tines with side eject 16, while on the left side the machine is equipped with one ore more standard hollow tines 20 with a top eject. The cores 17 are ejected from the side or from the top and typically fall somewhere behind the machine on the turf 15. If the core 17b is still in one piece, it is usually easier to remove it from the turf, but more difficult if it has broken in pieces 17a during the plugging. Often a deflector plate 21 may be mounted to the tine holder, to prevent the broken and/or substantially unbroken cores from entering inside the machine. Optionally the aerifier may be equipped with a core scraper 19 that windrows the cores over the turf in a row for easier removal afterwards. In this scenario, an extra collecting pass has to be made, which might damage the turf and close some of the holes 18 just made.

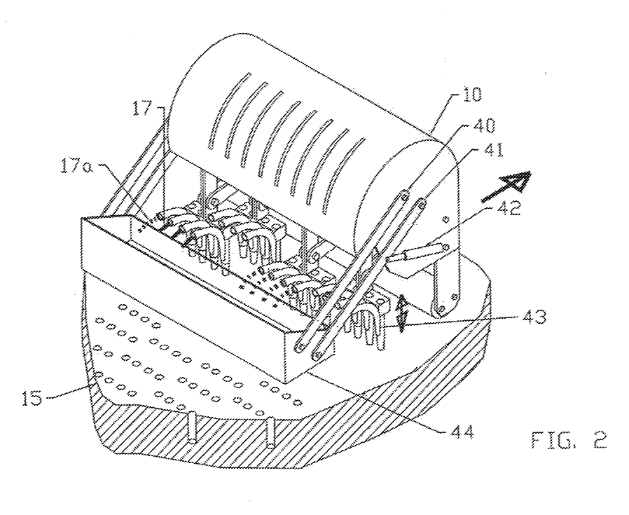

FIG. 2 is an embodiment of a common reciprocating aerifier, configured with hollow tines in combination with a collecting container, according to principles of the invention. The aerifier 10 may be configured with the hollow coring tines 43 constructed according to principles of the invention, which may eject the cores directly into a container 44, such as a box, bag or other container. The container 44 may be connected to the main frame of the aerifier 10 by utilizing two rods 40 and 41 at each side, for example. By utilizing a hydraulic cylinder 42, the collecting container 44 may be emptied directly into a trailer or similar device after a plugging pass has been made, or when full. In this mode, the turf 15 stays cleaner and is not damaged by any device which previously would have been towed over the turf for collecting the cores. Even if the cores 17 break during plugging 17a, the collection of the cores may be essentially total.

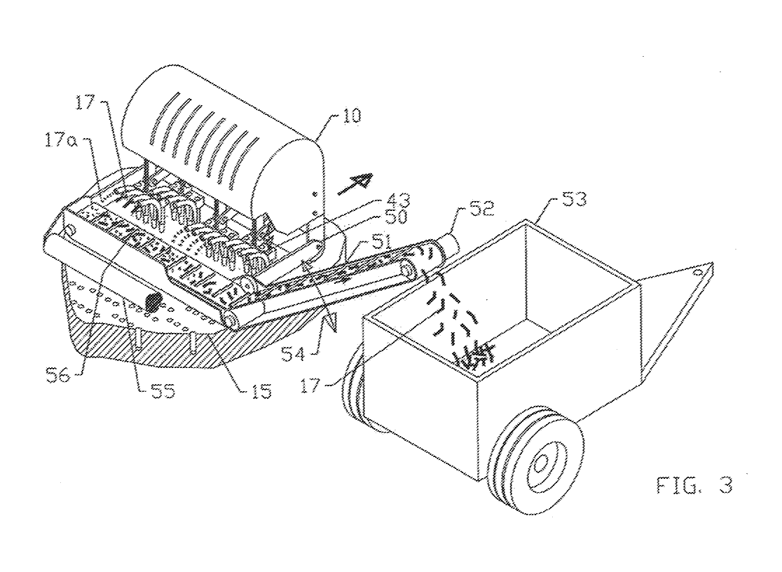

FIG. 3 is an embodiment of a common reciprocating aerifier, configured with hollow tines in combination with a conveyor belt for conveying the cores directly into a trailer, constructed according to principles of the invention. The aerifier 10 may achieve this task by moving the cores sidewards into a transport device 53, such as a trailer, for example. The conveyor belt may be driven with a hydraulic motor 52, for example. One advantage of the embodiment of FIG. 3 is that, in this example, the aerator 10 has more capacity when compared with FIG. 2, as the collecting container 44 doesn't need emptying as often. The whole conveyor device may be at the front pivotally connected 50 with a frame of the aerator 10 and at the rear supported by support roller 55. However, it is contemplated to mount the whole conveyor device to the aerator 10 so there is no turf contact after plugging the holes.

FIG. 4 is another exemplary embodiment of a common reciprocating aerifier, configured with hollow tines in combination with a processing device configured according to principles of the invention. The aerifier 10 of FIG. 4 may crunch the cores/plugs and spread the sand (or soil elements) portion of the plus/core back onto the turf. FIG. 4 illustrates cores 17 from the hollow coring tines 43 being thrown in a core processing device 66. This core processing device 66 may be configured with a shaft 61 and may be configured with special disks and/or an augur 62. The shaft may be driven by, for example, a hydraulic motor 60, or possibly a power-take-off from a tractor. When the cores 17 enter the core processing device 66, they may be crushed. The soil portion from the cores 17 may exit through slots 65 and may be evenly spread 63 back onto the turf. Often the sand or soil portions from the cores 17 can be re-used. The thatch may be taken apart by the augur 62. The core processing device may be pivotally connected 50 to the aerifier 10, supported by the wheel(s) 64 at the rear, tightly connected to the aerator 10, or may be used as a separate device.

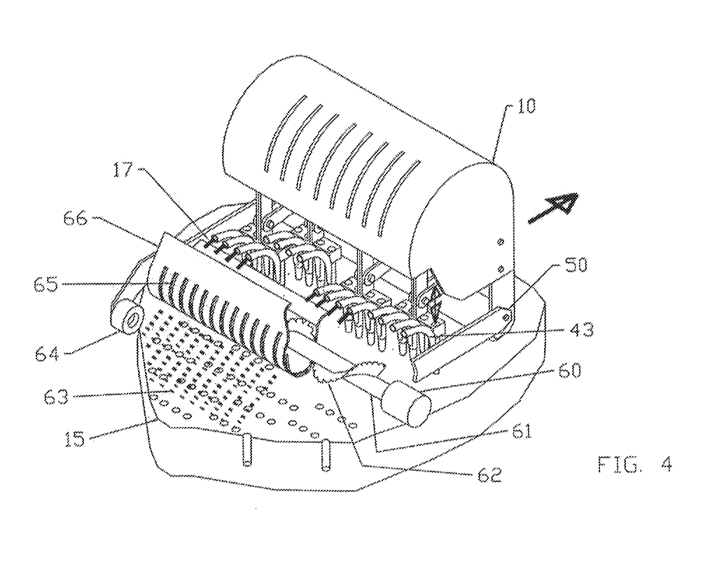

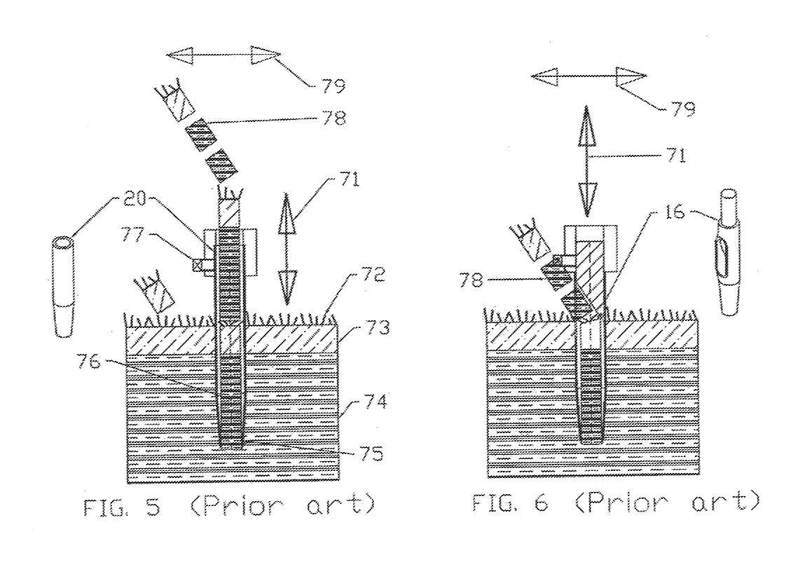

For a more detailed understanding of the coring process, some aspects are further explained in reference to FIGS. 5 and 6. FIG. 5 is a side view of a standard hollow coring tine with top eject, plugging a core, according to the prior art. FIG. 5 shows a standard hollow coring tine 20 with top eject, mounted in a tine head 77. This head may move substantially up and down 71, but may also move somewhat forward and backwards 79 when the tine departs from the soil (i.e., the turf soil). The turf layer typically has grass on top 72, a thatch layer 73 and finally the soil 74. The standard hollow coring tine 20 may have a tapered end 75 to create a relief when the core is cut. Also this tapered end may be useful to prevent the core 76 from falling out, and may be available in different sizes, with the characteristic that the hollow coring tine may have an extension that expels the cores in a vertical direction, when the hollow coring tine 20 departs the soil usually at relatively high speed 71. At the moment the next core is being plugged, this “new” core 76 pushes the other cores up. Since this typically occurs at high speed, the cores inside the coring tine 76 may fall apart 78. All these small parts 78 may end up flying in and/or around the machine.

FIG. 6 is a side view of a standard hollow coring tine with a side eject, plugging a core according to the prior art. This tine of FIG. 6 works the same as the hollow coring tine in FIG. 5, only the core 78 is ejected from the side of the tine. The side effect feature reduces the possibility of clogging of the core inside, when compared to FIG. 5, but still the defragmented cores 78 may fly around the machine and/or end up on the ground.

FIG. 7 is a side view of another embodiment of a hollow coring tine with top exit, configured according to principles of the invention. FIG. 7 includes a top eject hollow coring tine 20 with a sweep 85 on top, which may be incorporated as part of the tine (i.e., as a unified component), fixedly connected, or as a separate component that is removably connected, that guides all the individual cores in a pre-defined direction. The pre-determined direction may be adjustable. The sweep 85 may be configured to carry the one or more cores 78 through the enclosure of the sweep 85 to be expelled at a desired location such as the container 44. The sweep 85 may include one or more bends that direct the cores substantially horizontally away from the tine 20. In some aspects, the one or more bends may be created by manual application of force to the sweep 85. In one aspect, the sweep 85 may include at least one bend which may be formed by application of manual pressure to create the at least one bend for expelling the core in a desired direction. The sweep 85 may be configured to receive a core or plug traversing and exiting the hollow tine and configured to direct the core/plug in a direction away from the hollow tine while keeping the core/plug and any broken portions of the core/plug confined until expelled. The length of the sweep 85 may be several times the length of the length of a typical core. A typical core may range from about one inch to about two inches, but may vary in length. The sweep 85 may be considered a type of extension.

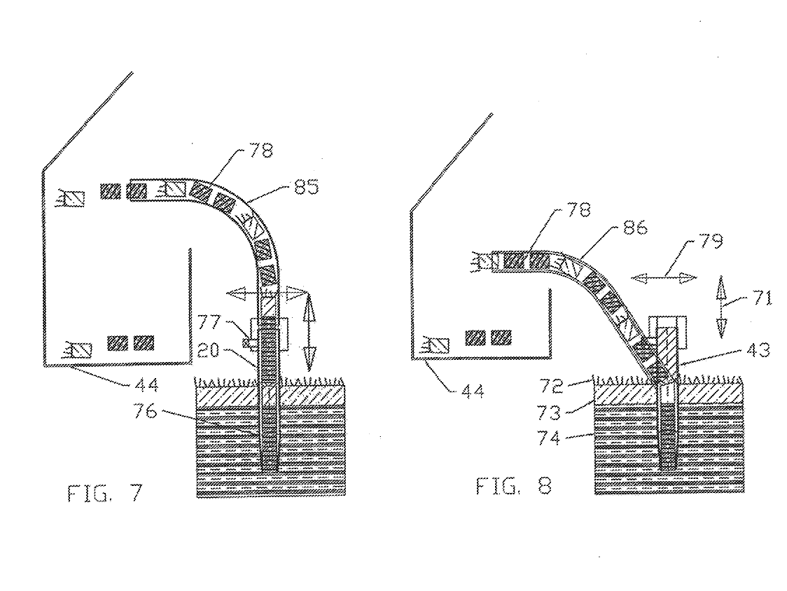

FIG. 8 is a side view of another embodiment of a hollow coring tine configured with side eject, configured according to principles of the invention. In FIG. 8 an extension 86 at the side eject tine 43, guides the cores/plugs 78 into the collecting container 44. In one aspect, the extension 86 may include at least one bend in the extent of the extension which may be formed by application of manual pressure to create the at least one bend for expelling the core/plug in a desired direction. The direction may be in a direction away from the side eject tine 43, usually directing the core/plug 78 in a substantially horizontal direction relative to a vertical axis of the side eject tine 43, but other direction are also contemplated. The extension 86 may be fixedly connected or removably connected to the side eject tine 43. In one aspect, the extension 86 and the side eject tine 43 may be constructed as a single unified component. The length of extension 86 may be more than the length of a typical unbroken core/plug, usually several times longer than the length of a typical unbroken core/plug. Core/plug length may vary, usually about 1 to about 2 inches in length, sometimes even longer.

FIG. 9 is a side view of another embodiment of a hollow coring tine configured with top eject, and a conduit for carrying the cores, configured according to principles of the invention. In FIG. 9 a flexible extension 91 may be constructed comprising a flexible type of conduit such as a hose mounted to the hollow coring tine 20. One advantage is that the weight of the extension, including the cores, may not create an extra load on the tine itself. By keeping a constant load on the tine, i.e., no extra load, a more consistent hole depth and uniform coring might be achieved. Also with the flexible extension 91, essentially all dust may be guided into a closed collecting container 93. The flexible extension 91 may be adjustable as required in an application. In some versions, the extension 91 may be at least partially semi-rigid. The flexible extension 91 may have a circumference and a length with at least one bend along its length. In one aspect, the hollow coring tine 20 may have a known circumference and the flexible extension 91 may be one of a plurality of extensions, each of the plurality of extensions may have a different size circumference for attaching to different tines each having different circumferences. That is, the extensions may be constructed in different sizes to mate with tines of different sizes. In one aspect, the flexible extension 91 may include at least one bend which may be formed by application of manual pressure to create the at least one bend for expelling the core in a desired direction. The flexible extension 91 may be configured to receive a plug traversing and exiting the hollow tine and configured to direct the plug in a direction away from the hollow tine while keeping the plug and any broken portions of the plug confined until expelled. The flexible extension 91 may comprise material sufficiently sturdy to maintain integrity over time (i.e., without ripping, tearing, cracking, etc) despite the reciprocating motion that the flexible material may be subjected to. The direction of flexible extension may result in a direction of expulsion of the plug of between more than zero degrees to about 180 degrees with respect to a vertical axis of the tine

In another aspect, a vacuum may be used in the collecting container 93, which may aid in sucking the cores 78 directly into the collecting container 93, analogous to a vacuum cleaner. Instead of pushing the cores through the flexible extension 91, the cores 78 may be pulled through, at least in part.

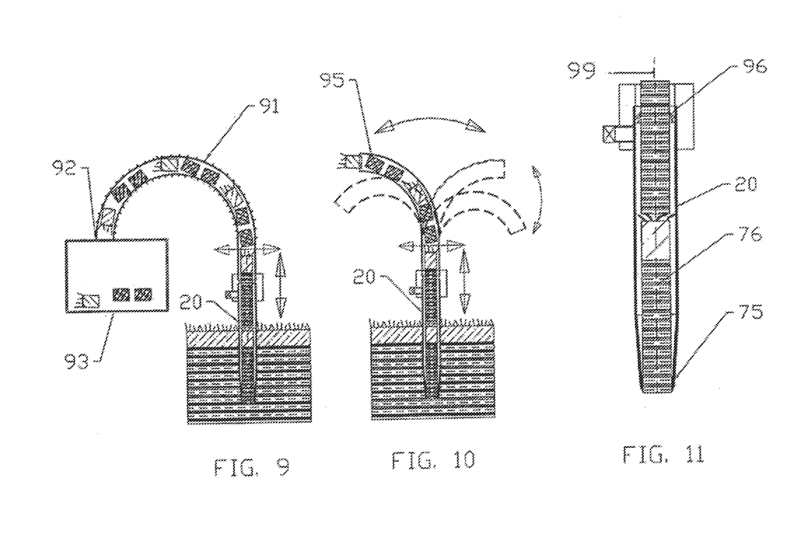

FIG. 10 is a side view of another embodiment of a hollow coring tine, showing that the extension can be set in different positions. FIG. 10 shows an example of a flexible extension 95, which may be set by hand in certain pre-determined positions, with a range of orientation in relation to the vertical plane from the ground, from about zero to about 90 degrees, but may vary to near 180 degrees. Alternatively, the flexible extension may be set in a position so that the resulting direction of expulsion may range from about 19:00 and 0:500 o'clock in relation to the vertical plane. The flexible extension may include at least one bend which may be formed by application of manual pressure to create the at least one stable bend for expelling the core in a desired direction. The flexible extension 95 may be configured to receive a plug traversing and exiting the hollow tine and configured to direct the plug in a direction away from the hollow tine while keeping the plug and any broken portions of the plug confined until expelled. The flexible extension 95 may also be configured to permit the flexible extension 95 to swivel around the vertical axis of the hollow tine 20. The flexible extension 95 may be configured to mate with existing tines to provide the advantages described. The flexible extension 95 has a circumference and a length. The length being more than the length of a typical unbroken plug, usually several times longer than the length of a typical plug. Plugs length vary, usually about 1 to about 2 inches in length, sometimes even longer.

FIG. 11 is a side view of another embodiment of a hollow tine, with a mechanism configured to prevent a core from moving backwards, according to principles of the invention. In FIG. 11, a retaining mechanism 96 may be mounted inside the hollow coring tine and/or extension. Because the hollow coring tine moves very fast up and down, the core 76 may fall out due to the mass inertia. For that reason, a retaining mechanism 96 may add friction in one direction.

The examples given above are merely illustrative and are not meant to be an exhaustive list of all possible embodiments, applications or modifications of the invention. Vertical axis 99 should be considered present in each tine embodiment herein. Thus, various modifications and variations of the described methods and systems of the invention will be apparent to those skilled in the art without departing from the scope and spirit of the invention. Although the invention has been described in connection with specific illustrative embodiments, it should be understood that the invention as claimed should not be unduly limited to such specific embodiments. The tines and extension herein may be constructed in different sizes to fit different tines and/or to accommodate different size core plugs. Indeed, various modifications of the described modes for carrying out the invention which are obvious to those skilled in the art or related fields are intended to be within the scope of the appended claims.

1. An apparatus for aerating turf for use with a hollow tine, comprising:
a hollow extension having a circumference and a length and having at least one bend along the length and configured to be connected to the hollow tine,
wherein the extension is configured to receive a plug traversing and exiting the hollow tine and configured to direct the plug in a direction away from the hollow tine while keeping the plug and broken portions of the plug confined until expelled at a predetermined direction and location.

2. The apparatus of claim 1, wherein the hollow extension is configured with a circumference to mate with a circumference of a respective hollow tine.

3. The apparatus of claim 1, wherein the hollow extension comprises flexible material.

4. The apparatus of claim 3, wherein the at least one bend provides a direction for expelling the plug and/or broken portions of the plug that ranges between more than zero degrees to about 180 degrees with respect to a vertical axis of the hollow tine.

5. The apparatus of claim 1, wherein the at least one bend is formable by application of manual pressure to create a bend for expelling the core in a desired direction.

6. The apparatus of claim 1, wherein the hollow extension attaches to an end of the hollow tine.

7. The apparatus of claim 1, wherein the hollow tine is a side ejection hollow tine and the hollow extension is configured to attach at a side of the side eject hollow tine.

8. The apparatus of claim 1, further comprising the hollow tine, the hollow tine configured with a mechanism to aid in preventing the plug from moving backward in the hollow tine.

9. The apparatus of claim 1, wherein the hollow extension is fixedly connected to the hollow tine.

10. The apparatus of claim 1, wherein the hollow extension is removably connected to the hollow tine.

11. An apparatus for aerating turf, comprising:
an aerifier configured to be propelled along the surface of the turf, the aerifier comprising:
a plurality of hollow tines configured to be moved in a vertical reciprocating manner while the aerifier is moved along the surface of the turf to remove one or more plugs from the turf; and
at least one hollow extension connected to a respective one of the plurality of hollow tines to expel the one or more plugs and/or portions thereof in a direction away from the respective one of the plurality of hollow tines.

12. The apparatus of claim 11, wherein the at least one hollow extension is removably connected to the respective one of the plurality of hollow tines.

13. The apparatus of claim 11, wherein the aerifier further includes a conveyor proximate the aerifier to receive the expelled one or more plugs from the at least one hollow extension to convey the one or more plugs away from the aerifier thereby substantially providing for collecting the one or more plugs in a container without discharge onto the turf.

14. The apparatus of claim 13, wherein the conveyor is pivotably attached to the aerifier.

15. The apparatus of claim 11, wherein the at least one hollow extension comprises flexible material and at least one bend is formable by manual pressure to permit expulsion of the one or more plugs in a desired direction.

16. The apparatus of claim 11, wherein at least one of the plurality of hollow tines is a side ejection hollow tine and the at least one hollow extension is configured to attach at a side of the side eject hollow tine.

17. The apparatus of claim 11, further comprising a vacuum source attached to the at least one hollow extension to aid in sucking the one or more plugs or portions thereof into a container.

18. The apparatus of claim 11, further comprising a collection container to receive the one or more plugs.

19. The apparatus of claim 18, wherein the collection container is pivotably attached to the aerifier.

20. The apparatus of claim 11, further comprising a core processing device that crunches the expelled one or more plugs and separates the turf from the soil portion or sand portion and spreads the soil portion or sand portion back onto the turf.

21. The apparatus of claim 20, wherein the core processing device is pivotably connected to the aerifier.

22. The apparatus of claim 11, further comprising a plug capturing mechanism to capture the expelled one or more plugs and/or portions thereof thereby avoiding returning the one or more plugs and/or portions thereof to the turf.

23. The apparatus of claim 11, wherein the a vertical reciprocating manner includes motion at an angle to vertical.

24. A method for aerating turf, comprising the steps of:
providing a plurality of hollow tines configured to be moved in a reciprocating manner while being moved along the surface of the turf to remove one or more plugs from the turf; and
providing at least one hollow extension connected to a respective one of the plurality of hollow tines to expel the one or more plugs and/or portions thereof in a direction away from the respective one of the plurality of hollow tines thereby facilitating convenient collection of the one or more plugs by a centralized collection technique for avoiding discarding of the one or more plugs back onto the turf.

25-36. (canceled)
